(19) United States
(12) Patent Application Publication
(10) Pub. No.: US 2018/0282582 A1
(43) Pub. Date: Oct. 4, 2018

(54) METHOD FOR ADHERING TWO MOTOR-VEHICLE PARTS WITH DIRECT HEATING OF ADHESIVE

(71) Applicant: Compagnie Plastic Omnium, Lyon (FR)

(72) Inventors: Francois VIRELIZIER, Saint Marcel Bel Accueil (FR); Jerome BRIZIN, Arbent (FR); Stephane GUILLIER, Dagneux (FR)

(73) Assignee: Compagnie Plastic Omnium, Lyon (FR)

(21) Appl. No.: 15/531,148

(22) PCT Filed: Nov. 24, 2015
(86) PCT No.: PCT/FR2015/053181

§ 371 Date: May 26, 2017

(30) Foreign Application Priority Data
Nov. 27, 2014 (FR) 1461560

(51) Int. Cl. C09J 5/06; C08J 5/12

(52) U.S. Cl. CPC C09J 5/06; C09J 2205/31; C08J 2323/12; C08J 2325/06; C08J 2377/00; C08J 2383/04; C09J 2423/106; C09J 2425/006; C09J 2477/006; C09J 2483/006; C08J 2475/04; C08J 2463/00; C08J 2433/10; C08J 2433/14; C09J 2475/00; C09J 2463/00; C09J 2433/00; C08J 5/121

(57) ABSTRACT

Method for adhering a first part made of plastic material (MP) and a second part, in which at least one thickness of adhesive is deposited onto at least one of said parts, and the other part is placed against the thickness of adhesive, wherein:
at least one electromagnetic wave of a given wavelength is selected, such that the transmission of said plastic material (MP) in relation to this wave is not zero, and such that the absorbance of the adhesive in relation to this wave is not zero; and
at least some of the adhesive is heated by irradiating it by transmitting said electromagnetic wave through said plastic material (MP) to activate and/or accelerate cross-linking of the adhesive.

### FIELD OF THE INVENTION

This invention relates to the field of assembly of motor vehicle parts, in particular assembly by adhering parts made of plastic material.

### BACKGROUND OF THE INVENTION

A method for assembling two parts together in an adhering installation is known in the state of the art. The installation generally comprises a support for positioning one of the parts relative to the other comprising two sections, often metallic, holding each part. The installation also comprises means for heating each section. Each metallic section heats the part it holds by thermal conduction.

Before positioning the two parts relative to each other, a thickness of adhesive, for example thermosetting, is applied on one and/or the other of the parts to be assembled. The two parts are then brought together and positioned relative to each other. The parts are now heated using heating means in order to activate or accelerate the cross-linking of the adhesive. Lastly, the assembled part is extracted from the installation.

In order to activate or accelerate the cross-linking of the thermosetting adhesive, the parts must be heated for a certain amount of time. During this time, the installation is occupied, resulting in dead time in the part manufacturing method. The assembly method in the state of the art therefore has a limited production capacity, depending on the cycle time required by the installation to assemble parts.

Moreover, heating the parts generates a high energy cost.

In addition, the heating means of the installation make it expensive and cumbersome.

Lastly, the cross-linking of the adhesive is activated or accelerated by providing heat by conduction by heating the parts to be adhered. This is due to the fact that the adhesive is inaccessible since it is in between the two parts. It is therefore impossible to heat the adhesive directly. However, heating the parts causes:
deformations due to differential expansions of the parts to be adhered;
problems of marks on the appearance surfaces; and
cycle times greater than one minute, involving significant capacity investment due to the need to use several adhering means to hold the parts in position or a capacity limited to the number of installations used.

Furthermore, since the plastic material is not a good heat conductor, the method is extremely difficult if the two parts to be adhered are made of plastic material.

### OBJECT AND SUMMARY OF THE INVENTION

The invention seeks to provide an adhering method to overcome these disadvantages. The invention achieves this by using a combination of materials/electromagnetic wave in order to heat the adhesive directly.

Thus, the invention relates to a method for adhering a first part made of plastic material and a second part, wherein at least one thickness of adhesive is deposited onto at least one of said parts, and the other part is placed against the thickness of adhesive. According to the method, at least one electromagnetic wave of a given wavelength is selected, such that the transmission of said plastic material in relation to this wave is not zero, and such that the absorbance of the adhesive in relation to this wave is not zero; and at least some of the adhesive is heated by irradiating it directly by transmitting said electromagnetic wave through said plastic material to activate and/or accelerate cross-linking of the adhesive.

This method drastically reduces the cycle times by heating the adhesive directly. Consequently, there is no need to wait for the first part to heat and progressively transmit its heat to the adhesive.

Preferably, at least one electromagnetic wave is selected such that the absorbance of said plastic material in relation to this wave is not zero.

Preferably also, at least one electromagnetic wave is selected such that the transmission of the adhesive in relation to this wave is not zero.

According to the invention, an electromagnetic wave of wavelength greater than 780 nm, and/or less than 2500 nm can be selected.

According to an embodiment, a set of electromagnetic waves is transmitted, of wavelengths between 400 nm and 5000 nm, and preferably between 780 nm and 2500 nm.

A set of electromagnetic waves can be transmitted by means of an infrared transmitter, for example.

An electromagnetic wave can be transmitted by means of a laser source, for example.

According to an embodiment, said electromagnetic wave is transmitted until, after cross-linking at least some of the adhesive, the assembly of the two parts can be handled without the parts moving relative to each other.

According to the invention, the plastic material can be selected from the following materials: a thermoplastic material such as a polyolefin or a styrene thermoplastic or a polyamide, a thermosetting material, a silicone.

According to the invention, the adhesive can be selected from the following adhesives: polyurethane, epoxy, methacrylate, cyanoacrylate.

According to an embodiment, a plastic material comprising a dye is used, the dye being selected such that the transmission of the wave through said dye is not zero.

According to an embodiment, at least one of the parts is preheated before positioning the second part, and the electromagnetic wave is selected according to the temperature of the first part thus preheated.

The invention also relates to an installation for adhering a first part made of plastic material and a second part, comprising:
a support for positioning one of the parts relative to the other; and
at least one means of transmitting at least one electromagnetic wave through said plastic material.

Advantageously, the transmission means can be adapted to transmit electromagnetic waves of wavelengths between 400 nm and 5000 nm, preferably between 780 nm and 2500 nm.

Lastly, the transmission means may comprise at least an infrared transmitter and/or an infrared lamp and/or a laser source.

### BRIEF DESCRIPTION THE DRAWINGS

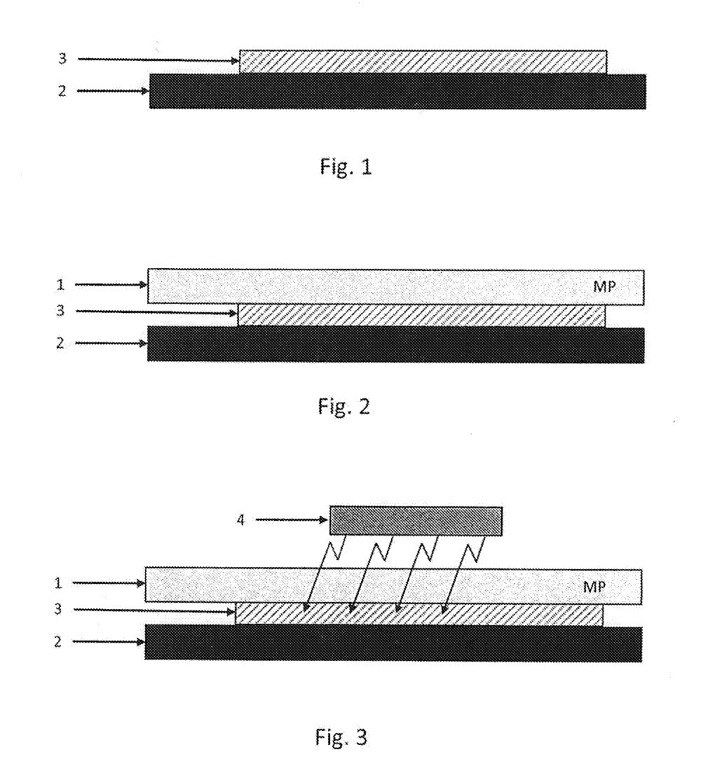

It will be easier to understand the invention on reading the attached FIGS. 1 to 3, which are given solely by way of example and not limiting in any way, and which describe the method according to the invention.

### MORE DETAILED DESCRIPTION

We now refer to these FIGS. 1 to 3, which describe the method according to the invention, for adhering a first part (1) made of plastic material (MP) and a second part (2). It comprises the following steps:
at least one thickness of adhesive (3) is deposited (FIG. 1) onto at least one of said parts (1, 2); a thickness means the quantity of adhesive required to assemble the two parts (1, 2), irrespective of the shape and thickness of this quantity (bead, film, blob, etc.);
the other part (2, 1) is positioned (FIG. 2) against the thickness of adhesive (3);
at least one electromagnetic wave of a given wavelength is selected, such that the transmission of said plastic material (MP) in relation to this wave is not zero, and such that the absorbance of the adhesive (3) in relation to this wave is not zero; and
at least some of the adhesive (3) is heated (FIG. 3) by irradiating it by transmitting said electromagnetic wave through said plastic material (MP) to activate and/or accelerate cross-linking of the adhesive (3).

Plastic material means a material composed of a set of polymers. The thermoplastic materials (based on styrene, polyamide and/or polyolefin materials such as polypropylene, etc.), the thermosetting materials (based on vinyl ester, epoxy resin, etc.), and the silicones are known.

According to the invention, the plastic material may consist of resin loaded with additives (carbon black, talc, etc.) and/or reinforced by reinforcing elements, such as glass or carbon fibers, for example.

The two parts can be made of plastic material, the same plastic material or different plastic materials.

In the automotive industry, it is known to use certain adhesives for adhering parts made of plastic material. Thus, in the context of the invention, adhesives (3) such as polyurethane, epoxy, methacrylate, and/or cyanoacrylate adhesives can be used. These adhesives may be single-component adhesives (this type of adhesive cross-links with external factors such as humidity in the air), single-component adhesives comprising a second “encapsulated” component, adhesives with two components mixed together, and/or thermally activated adhesives.

After depositing at least one thickness of adhesive (3) onto at least one of the parts (1, 2), the other part (2, 1) is positioned against the thickness of adhesive (3) then cross-linking of the adhesive (3) is activated or accelerated.

According to the invention, to activate and/or accelerate the cross-linking of the adhesive (3), at least some of this adhesive (3) is heated by irradiating it.

The adhesive is irradiated by transmitting an electromagnetic wave through the plastic material (MP) using a transmission means (4).

This electromagnetic wave is selected so as to irradiate, at least partially, the adhesive directly, in order to heat the adhesive directly, and not by conduction, i.e. by heating the first part which would then transmit its heat. Direct irradiation of the adhesive means that some of the wave passing through the plastic material reaches the adhesive directly to provide it with energy as heat.

To do this, at least one wave of given wavelength is selected, such that the transmission of this wave in the plastic material (MP) is not zero, and such that the absorbance of this wave in the adhesive is not zero.

The absorbance of a medium measures the ability of this medium to absorb the electromagnetic wave passing through it. The transmission (or transmittance) of a medium is defined as being the reciprocal of the absorbance. It is therefore the fraction of the flux passing through the medium. For visible light, we speak of transparency.

To measure these two properties, a spectrophotometer is generally used, which provides a percentage corresponding to the fraction of the flux passing through the medium (transmission) or the fraction of the flux absorbed by the medium (absorbance). The absorbance and the transmission vary depending on the type of material studied, the wavelength under which it is analyzed, and the thickness (or concentration) of this material in the medium crossed.

Thus, irrespective of the measurement means used, a wave of given wavelength will be selected having the transmission and absorbance properties required for the selected plastic material (MP) and for the selected adhesive (3), but also for the thickness of the first part (1) and for the thickness of adhesive used for adhering.

Obviously, it is possible to extrapolate, or make a selection on different thicknesses, subject to verifying the proper consistency of the properties on the thicknesses required for the adhering operation.

Throughout the description, the transmission and the absorbance of the plastic material (MP) are defined in relation to the thickness of the first part (1), and the transmission and the absorbance of the adhesive (3) are defined in relation to the thickness of the bead of adhesive.

Preferably, a wave which is totally transmitted by the plastic material is not selected. Choosing a wave for which the plastic material (MP) is nevertheless absorbent (absorbance not zero), provides a means of heating the first part (1), and thus, heating the adhesive also by conduction (the heated part heats the adhesive). This offers the advantage firstly of accelerating the heating of the adhesive, and secondly of keeping the adhesive at the cross-linking temperature.

Furthermore, preferably, a wave which is totally absorbed by the adhesive is not selected. Choosing a wave for which the adhesive is nevertheless transparent (transmission not zero) provides a means of reaching the second part (2) and therefore of heating the entire thickness of the adhesive (3). Homogeneous heating is therefore obtained, by avoiding heating only the upper layer of the adhesive.

Those requirements in terms of transmission and wavelength, are readily fulfilled for the plastic materials and adhesives used in the field of the automotive industry. Those skilled in the art will therefore easily be able to select the appropriate length(s). In particular, they can refer to books such as R. Klein, Laser Welding of Plastic, Wiley- VCH, p. 55, 64, in which the transmission or absorbance curves as a function of the wavelength are provided for different plastic materials.

Such curves can also be readily obtained for all plastic materials or all adhesives used in the automotive industry, by means of a spectrophotometer, for example.

Furthermore, those skilled in the art will be able to produce trial-and-error type experience plans to determine the best wavelength, depending on the energy required to activate and/or accelerate the cross-linking of the thickness of adhesive (3).

In fact, depending on the plastic material (MP), any additives of this material (MP), the thickness of the part (1), the adhesive (3) and its thickness required for the application, those skilled in the art will be able to choose the wavelength(s) required, the power to be provided and the exposure time. Furthermore, those skilled in the art will select the type of transmission means (4) suitable for the application.

Thus, by way of non-limiting example, for a laser head of power 400 W and an irradiation area of 40×40 cm², a first part (1) of thickness 3 mm made of polypropylene (PP GFL 40%), an area of adhesive of 20 cm² (length 20 cm and width 1 cm) and a thickness of adhesive of 5 mm, an electromagnetic wave can be selected such that the transmission of the plastic material (MP) in the part (1) in relation to this wave is greater than 10%, preferably greater than 20%, and such that the transmission of the adhesive (3) in the thickness of adhesive in relation to this wave is less than 90%, preferably less 50%. According to this example, a wavelength of approximately 940 nm can be selected.

Thus, according to an embodiment example, an electromagnetic wave of wavelength greater than 780 nm is used. These waves are ideally suited to the above-mentioned plastic materials in combination with the above-mentioned adhesives.

According to another example, an electromagnetic wave of wavelength less than 2500 nm is used. These waves are ideally suited to the above-mentioned plastic materials in combination with the above-mentioned adhesives.

Thus, according to an embodiment example particularly well suited to the materials used in the automotive industry, an electromagnetic wave of wavelength greater than 780 nm and less than 2500 nm is used.

According to an embodiment, a set (a range) of electromagnetic waves is transmitted, each wavelength respecting the constraints imposed in terms of transmission and absorption in relation to the plastic material and the adhesive. Preferably, these waves have wavelengths between 400 nm and 5000 nm, preferably between 780 nm and 2500 nm.

This type of electromagnetic wave lies in particular in the near infrared (or short infrared) range. This set of electromagnetic waves can be transmitted by means of an infrared transmitter, such as an infrared lamp.

If the use of a single wavelength is desired, a laser source is preferably used.

According to an embodiment, irradiation is stopped before the adhesive is completely cross-linked. The electromagnetic wave is in fact transmitted until, after cross-linking at least some of the adhesive (3), the assembly of the two parts (1, 2) can be handled without the parts moving relative to each other.

This accelerates the production cycle time, cross-linking of the adhesive being completed during dead times (for example, during the times of transfer to the next station or the storage times).

According to another embodiment, if the first part is to be colored, a dye is selected such that the transmission of the wave through said dye is not zero, and a plastic material (MP) comprising said dye is used, or this dye is added to an existing plastic material.

According to another embodiment, at least one of the parts (1, 2) is preheated before positioning the second part (2).

The invention also relates to an installation for adhering a first part (1) made of plastic material (MP) and a second part (2). The installation comprises:
a support for positioning one of the parts relative to the other; and
at least one means of transmitting at least one electromagnetic wave through said plastic material (MP).

The transmission means are preferably adapted to transmit electromagnetic waves of wavelengths between 400 nm and 5000 nm, preferably between 780 nm and 2500 nm.

The transmission means comprise at least an infrared transmitter and/or an infrared lamp and/or a laser source.

One advantage of using an infrared lamp is that the heat input is distributed better than with a laser whose photons are directed perpendicular to the surface.

1. A method for adhering a first part and a second part, wherein at least one layer of adhesive is deposited onto one of the first part and the second part, and the other of the first part and the second part is placed against the layer of adhesive, the method comprising:
selecting at least one electromagnetic wave of a wavelength such that:
a transmission of said plastic material in relation to the at least one electromagnetic wave is not zero, and
an absorbance of the adhesive in relation to the at least one electromagnetic wave is not zero; and
heating at least a portion of the adhesive layer by directly irradiating the adhesive by transmitting said at least one electromagnetic wave through said plastic material to activate and/or accelerate cross-linking of the adhesive.

2. The method according to claim 1, wherein an absorbance of said plastic material in relation to the at least one electromagnetic wave is not zero.

3. The method according to claim 1, wherein transmission of the adhesive in relation to the at least one electromagnetic wave is not zero.

4. The method according to claim 1, wherein the at least one electromagnetic wave has a wavelength that is greater than 780 nm.

5. The method according to claim 1, wherein the electromagnetic wave has a wavelength that is less than 2500 nm.

6. The method according to claim 1, wherein the at least one electromagnetic wave has a wavelength between 400 nm and 5000 nm.

7. The method according to claim 1, wherein the at least one electromagnetic wave is transmitted via an infrared transmitter.

8. The method according to claim 1, wherein said at least one electromagnetic wave is transmitted via a laser source.

9. The method according to claim 1, wherein said electromagnetic wave is transmitted until, after cross-linking at least some of the adhesive, assembly of the first part and the second part takes place without the first part and the second part moving relative to each other.

10. The method according to claim 1, wherein the plastic material is selected from a polyolefin (polypropylene), a styrene thermoplastic, a polyamide, a thermosetting material, and a silicone.

11. The method according to claim 1, wherein the adhesive is selected from polyurethane, epoxy, methacrylate, and cyanoacrylate.

12. The method according to claim 1, wherein the plastic material comprises a dye selected such that a transmission of the at least one electromagnetic wave through said dye is not zero.

13. The method according to claim 1, wherein at least one of the first part and the second part is preheated before positioning the second part, and the electromagnetic wave is selected according to a temperature of the preheated at least one of the first part and the second part.

14. An apparatus for adhering a first part and a second part, the first part including plastic material, the apparatus comprising:
a support for positioning one of the first part and the second part relative to the other one of the first part and the second part; and
at least one means of transmitting at least one electromagnetic wave through said plastic material.

15. The apparatus according to claim 14, wherein the at least one means of transmitting are configured to transmit electromagnetic waves in a range of wavelengths between 400 nm and 5000 nm.

16. The apparatus according to claim 14, wherein the means of transmitting comprise at least one of an infrared transmitter, an infrared lamp and a laser source.

17. The method according to claim 6, wherein the at least one electromagnetic wave has a wavelength between 780 nm and 2500 nm.

18. A method for adhering a first part and a second part, the first part including plastic material, the method comprising:
depositing at least one layer of adhesive onto at least one of the first part and the second part;
placing the other of the first part and the second part against the layer of adhesive;
selecting at least one electromagnetic wave having a wavelength such that:
a transmission of the at least one electromagnetic wave through the plastic material is not zero, and
an absorbance of the at least one electromagnetic wave by the adhesive is not zero; and
irradiating the adhesive with the at least one electromagnetic wave through the first part to heat at least a portion of the adhesive by activating and/or accelerating cross-linking thereof.

19. The method of claim 18, wherein the irradiating comprises irradiating the adhesive in a wavelength range between 400 nm and 5000 nm.

20. The method of claim 19, wherein the irradiating comprises irradiating the adhesive in a wavelength range between 780 nm and 2500 nm.
